(19) United States
(12) Patent Application Publication
(10) Pub. No.: US 2017/0362960 A1
(43) Pub. Date: Dec. 21, 2017

(54) TURBINE CASE BOSS

(71) Applicant: UNITED TECHNOLOGIES CORPORATION, Farmington, CT (US)

(72) Inventors: Christopher Treat, Manchester, CT (US); Jeffrey H. Huang, Glastonbury, CT (US); Caroline Karanian, West Hartford, CT (US)

(73) Assignee: UNITED TECHNOLOGIES CORPORATION, Farmington, CT (US)

(21) Appl. No.: 15/188,170

(22) Filed: Jun. 21, 2016

(51) Int. Cl. F01D 25/24; F01D 25/28

(52) U.S. Cl. CPC F01D 25/24; F01D 25/28; F05D 2230/237; F05D 2230/10; F05D 2220/32; F05D 2230/30; F05D 2230/21

(57) ABSTRACT

A stiffness boss for a turbine case of a gas turbine engine is disclosed. The stiffness boss includes a head portion disposed on an outer case surface of the turbine case, the head portion configured to provide rigidity in response to a transverse load being applied to the turbine case in a transverse direction. The stiffness boss also includes a leg portion disposed on the outer case surface of the turbine case and connected to the head portion, the leg portion configured to provide rigidity in response to an axial load being applied to the turbine case in an axial direction, such that deformation of the turbine case is resisted.

### FIELD

The present disclosure relates to turbine cases and, more particularly, to bosses for turbine cases of gas turbine engines.

### BACKGROUND

Turbine frame cases, such as a mid-turbine frame outer case, may contain bosses used to attach external parts. At some locations where no external parts are attached, the bosses may be in an unattached condition. Removing the boss from the case may create asymmetric stiffness. Accordingly, unused bosses may be left intact to maintain symmetric stiffness of the case.

### SUMMARY

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

A stiffness boss for a turbine case of a gas turbine engine is disclosed. The stiffness boss includes a head portion disposed on an outer case surface of the turbine case, the head portion configured to provide rigidity in response to a transverse load being applied to the turbine case in a transverse direction. The stiffness boss also includes a leg portion disposed on the outer case surface of the turbine case and connected to the head portion, the leg portion configured to provide rigidity in response to an axial load being applied to the turbine case in an axial direction, such that deformation of the turbine case is resisted.

In any of the foregoing stiffness bosses, the head portion and the leg portion provide rigidity in response to a radial load being applied to the turbine case in a radially inward direction.

In any of the foregoing stiffness bosses, the head portion has a head length and head width determined to provide optimized rigidity and minimized weight.

In any of the foregoing stiffness bosses, the leg portion has a leg length and leg width determined to provide optimized rigidity and minimized weight.

In any of the foregoing stiffness bosses, the head portion is flat and is substantially parallel to an axis of the gas turbine engine.

In any of the foregoing stiffness bosses, the leg portion is flat and sloped radially inward.

In any of the foregoing stiffness bosses, the head portion and the leg portion are connected to the outer case surface by a filleted portion.

In any of the foregoing stiffness bosses, the filleted portion is curved radially inward.

A turbine case of a gas turbine engine is disclosed. The turbine case includes an outer case surface. The turbine case also includes a support member boss configured to secure support structures of the gas turbine engine. The turbine case also includes a stiffness boss disposed on the outer case surface and configured to provide rigidity in response to one or more loads applied to the turbine case, the stiffness boss being different from the support member boss.

In any of the foregoing turbine cases, the stiffness boss is a gusseted boss configured to provide rigidity in response to at least one of a transverse load, an axial load, or a radial load applied to the turbine case.

In any of the foregoing turbine cases, the stiffness boss comprises a head portion configured to provide rigidity in response to a transverse load being applied to the turbine case in a transverse direction, and a leg portion configured to provide rigidity in response to an axial load being applied to the turbine case in an axial direction, such that deformation of the outer case is resisted.

In any of the foregoing turbine cases, the head portion and the leg portion provide rigidity in response to a radial load being applied to the turbine case in a radially inward direction.

In any of the foregoing turbine cases, the head portion has a head length and head width determined to provide optimized rigidity and minimized weight.

In any of the foregoing turbine cases, the leg portion has a leg length and leg width determined to provide optimized rigidity and minimized weight.

In any of the foregoing turbine cases, the head portion is flat and is substantially parallel to an axis of the gas turbine engine.

In any of the foregoing turbine cases, the leg portion is flat and sloped radially inward.

In any of the foregoing turbine cases, the stiffness boss is at least one of welded, brazed, additively manufactured, machined, or cast on the outer case surface.

In any of the foregoing turbine cases, the stiffness boss and the turbine case are made of different materials.

A method of fabricating a turbine case is disclosed. The method includes disposing a head portion of a stiffness boss on an outer surface of the turbine case, the head portion configured to provide rigidity in response to a transverse load being applied to the turbine case. The method further includes disposing a leg portion of the stiffness boss on the outer surface of the turbine case, the leg portion configured to provide rigidity in response to an axial load being applied to the turbine case.

In any of the foregoing methods, the method further includes determining a head length and a head width of the head portion by optimizing rigidity and minimizing weight and determining a leg length and a leg width of the leg portion by optimizing rigidity and minimizing weight.

### BRIEF DESCRIPTION OF THE DRAWINGS

Various features will become apparent to those skilled in the art from the following detailed description of the disclosed, non-limiting, embodiments. The drawings that accompany the detailed description can be briefly described as follows:

FIG. 1 is a schematic cross-section of a gas turbine engine having a turbine case, in accordance with various embodiments;

FIG. 2 is a perspective view of an outer case, in accordance with various embodiments;

FIG. 3 is a portion of the outer case including a stiffness boss, in accordance with various embodiments;

FIG. 4 illustrates a cross-section of the stiffness boss from a first orientation, in accordance with various embodiments; and

FIG. 5 illustrates a cross-section of the stiffness boss from a second orientation opposite the first orientation across a circumferential axis, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice embodiments of the disclosure, it should be understood that other embodiments may be realized and that logical changes and adaptations in design and construction may be made in accordance with this invention and the teachings herein. Thus, the detailed description herein is presented for purposes of illustration only and not limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact. As used herein, “approximately” or “substantially” may refer to a measurement or dimension within 10% of the corresponding measurement of the referenced object. For example, a length that is substantially or approximately equal to a length of 10 feet may be between 9 feet and 11 feet.

Furthermore, any reference to singular includes plural embodiments, and any reference to more than one component or step may include a singular embodiment or step. Surface shading lines may be used throughout the figures to denote different parts but not necessarily to denote the same or different materials.

As used herein, “aft” refers to the direction associated with the exhaust (e.g., the back end) of a gas turbine engine. As used herein, “forward” refers to the direction associated with the intake (e.g., the front end) of a gas turbine engine.

A first component that is “radially outward” of a second component means that a first component is positioned at a greater distance away from the engine central longitudinal axis, than the second component. A first component that is “radially inward” of a second component means that the first component is positioned closer to the engine central longitudinal axis, than the second component. In the case of components that rotate circumferentially about the engine central longitudinal axis, a first component that is radially inward of a second component rotates through a circumferentially shorter path than the second component. The terminology “radially outward” and “radially inward” may also be used relative to references other than the engine central longitudinal axis.

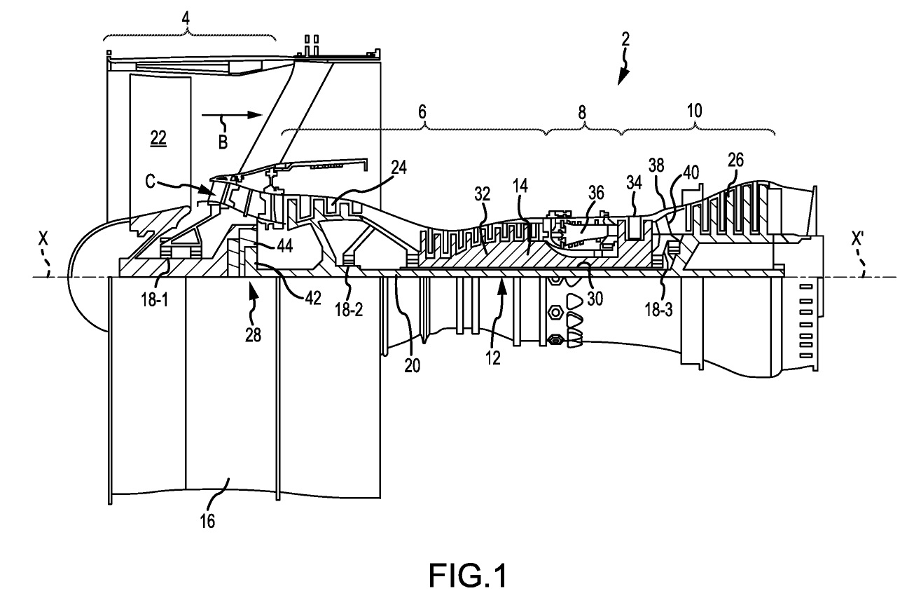

In various embodiments and with reference to FIG. 1, an exemplary gas turbine engine 2 is provided. Gas turbine engine 2 may be a two-spool turbofan that generally incorporates a fan section 4, a compressor section 6, a combustor section 8 and a turbine section 10. Alternative engines may include, for example, an augmentor section among other systems or features. In operation, fan section 4 can drive air along a bypass flow-path B while compressor section 6 can drive air along a core flow-path C for compression and communication into combustor section 8 then expansion through turbine section 10. Although depicted as a turbofan gas turbine engine 2 herein, it should be understood that the concepts described herein are not limited to use with turbofans as the teachings may be applied to other types of turbine engines including three-spool architectures.

Gas turbine engine 2 may generally comprise a low speed spool 12 and a high speed spool 14 mounted for rotation about an engine central longitudinal axis X-X′ relative to an engine static structure 16 via several bearing systems 18-1, 18-2, and 18-3. It should be understood that various bearing systems at various locations may alternatively or additionally be provided, including for example, bearing system 18-1, bearing system 18-2, and bearing system 18-3.

Low speed spool 12 may generally comprise an inner shaft 20 that interconnects a fan 22, a low pressure compressor section 24 (e.g., a first compressor section) and a low pressure turbine section 26 (e.g., a first turbine section). Inner shaft 20 may be connected to fan 22 through a geared architecture 28 that can drive the fan 22 at a lower speed than low speed spool 12. Geared architecture 28 may comprise a gear assembly 42 enclosed within a gear housing 44. Gear assembly 42 couples the inner shaft 20 to a rotating fan structure. High speed spool 14 may comprise an outer shaft 30 that interconnects a high pressure compressor section 32 (e.g., second compressor section) and high pressure turbine section 34 (e.g., second turbine section). A combustor 36 may be located between high pressure compressor section 32 and high pressure turbine section 34. A mid-turbine frame 38 of engine static structure 16 may be located generally between high pressure turbine section 34 and low pressure turbine section 26. Mid-turbine frame 38 may support one or more bearing systems 18 (such as 18-3) in turbine section 10. Inner shaft 20 and outer shaft 30 may be concentric and rotate via bearing systems 18 about the engine central longitudinal axis X-X′, which is collinear with their longitudinal axes. As used herein, a “high pressure” compressor or turbine experiences a higher pressure than a corresponding “low pressure” compressor or turbine.

The core airflow C may be compressed by low pressure compressor section 24 then high pressure compressor section 32, mixed and burned with fuel in combustor 36, then expanded over high pressure turbine section 34 and low pressure turbine section 26. Mid-turbine frame 38 includes airfoils 40, which are in the core airflow path. Turbines 26, 34 rotationally drive the respective low speed spool 12 and high speed spool 14 in response to the expansion.

Gas turbine engine 2 may be, for example, a high-bypass geared aircraft engine.

In various embodiments, the bypass ratio of gas turbine engine 2 may be greater than about six (6). In various embodiments, the bypass ratio of gas turbine engine 2 may be greater than ten (10). In various embodiments, geared architecture 28 may be an epicyclic gear train, such as a star gear system (sun gear in meshing engagement with a plurality of star gears supported by a carrier and in meshing engagement with a ring gear) or other gear system. Geared architecture 28 may have a gear reduction ratio of greater than about 2.3 and low pressure turbine section 26 may have a pressure ratio that is greater than about 5. In various embodiments, the bypass ratio of gas turbine engine 2 is greater than about ten (10:1). In various embodiments, the diameter of fan 22 may be significantly larger than that of the low pressure compressor section 24, and the low pressure turbine section 26 may have a pressure ratio that is greater than about 5:1. Low pressure turbine section 26 pressure ratio may be measured prior to inlet of low pressure turbine section 26 as related to the pressure at the outlet of low pressure turbine section 26 prior to an exhaust nozzle. It should be understood, however, that the above parameters are exemplary of various embodiments of a suitable geared architecture engine and that the present disclosure contemplates other turbine engines including direct drive turbofans.

In various embodiments, the next generation of turbofan engines may be designed for higher efficiency, which may be associated with higher pressure ratios and higher temperatures in the high speed spool 14. These higher operating temperatures and pressure ratios may create operating environments that may cause thermal loads that are higher than thermal loads conventionally encountered, which may shorten the operational life of current components. In various embodiments, operating conditions in high pressure compressor section 32 may be approximately 1400° F. (approximately 760° C.) or more, and operating conditions in combustor 36 may be higher.

In various embodiments, combustor section 8 may comprise one or more combustor 36. As mentioned, the core airflow C may be compressed, then mixed with fuel and ignited in the combustor 36 to produce high speed exhaust gases.

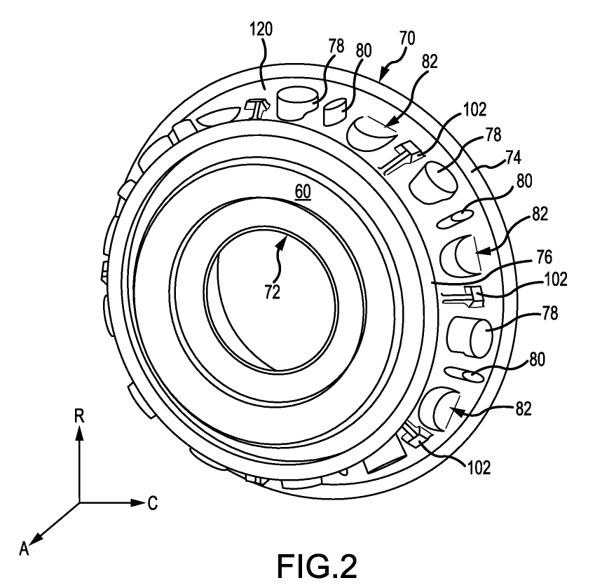

With reference to FIG. 2, a perspective view of outer case 70 is shown. Outer case 70 may be used in a mid-turbine frame 38, discussed above with respect to FIG. 1, which in addition to outer case 70 includes airfoils 40 (shown in FIG. 1). Although described with respect to mid-turbine frame 38, stiffness bosses 102 may be used in any portion of the outer case in which rigidity control of the case is desired. An A-R-C axis is shown throughout the drawings to illustrate the axial, radial and circumferential (or transverse) directions.

Outer case 70 includes outer flange 74 and inner flange 76 for connection to aft and forward case assemblies, respectively. Outer flange 74 has a greater diameter than inner flange 76 and inner flange 76 is located axially forward of outer flange 74, in the positive A direction. This orientation results in outer case 70 having outer case surface 120, which is between outer flange 74 and inner flange 76, sloping radially inward (in the negative R direction and the positive A direction). Outer case 70 further includes multiple support member bosses 78 disposed circumferentially around outer case 70 for receiving and securing support structures such as struts or rods that communicate forces radially inward in the negative R direction. Additionally, multiple spoke bosses 80 are similarly disposed circumferentially around outer case 70 that allow for attachment of parts used in various functions of the outer case 70 and gas turbine engine 2, in general.

In addition, multiple gusseted bosses 82 are disposed circumferentially around outer case 70, and between support member bosses 78 and/or spoke bosses 80. Gusseted bosses 82 provide system stiffness symmetry, thereby minimizing deformation of the outer case 70 and centerline shift. The interior of gusseted boss 82 may be hollow, which reduces the weight of outer case 70 without affecting the load bearing capability of outer case 70. However, the process of fabricating the gusseted boss 82 may be time consuming, as it may be machined on both sides in order to achieve its hollow configuration.

Load applied at the support member bosses 78 and the spoke bosses 80 may be counteracted with reinforced, stiffened regions between the points of contact, such that the outer case 70 resists deformation. To this end, stiffness bosses 102 are fabricated to assist in resisting deformation of the outer case 70.

Instead of fabricating more gusseted bosses 82 or unused spoke bosses 80, stiffness bosses 102 may be used to reinforce rigidity of the outer case 70 and maintain the outer case 70 shape. In particular, the geometry of stiffness bosses 102, and the placement of stiffness bosses 102 circumferentially around outer case 70, provides additional stiffness to outer case 70 that resists or prevents deforming of outer case 70 in response to forces applied via support member bosses 78 and spoke bosses 80. Stiffness bosses 102 may be manufactured on one side of the outer case 70, making them less expensive to manufacture than gusseted bosses 82, which may be machined from both sides. Stiffness bosses 102 may also be lighter and may use fewer materials to manufacture than unused spoke bosses 80. In various embodiments, gusseted bosses may be a type of stiffness boss. Gusseted bosses may provide rigidity in response to a radial load applied to the outer case 70. Gusseted bosses may also provide rigidity in response to an axial load applied to the outer case 70. Gusseted bosses may also provide rigidity in response to a transverse load applied to the outer case 70.

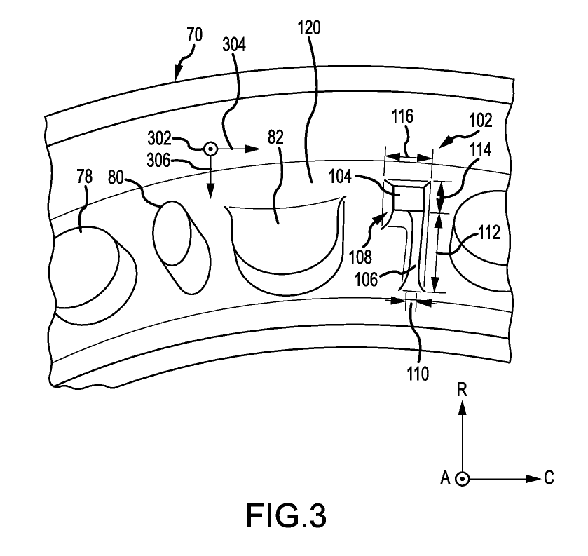

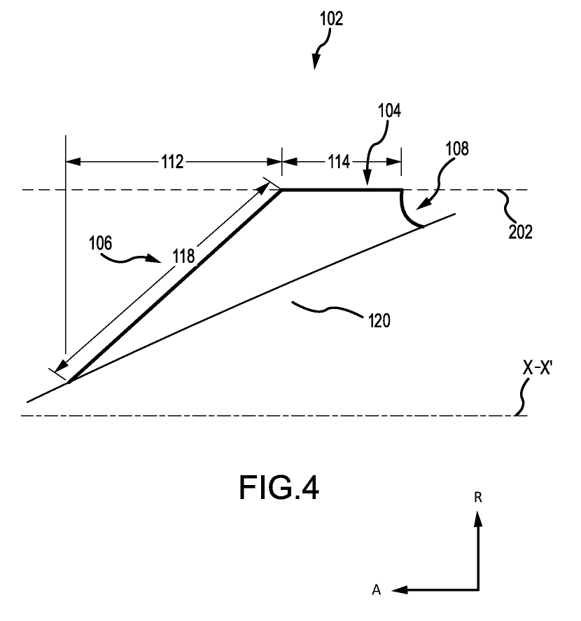

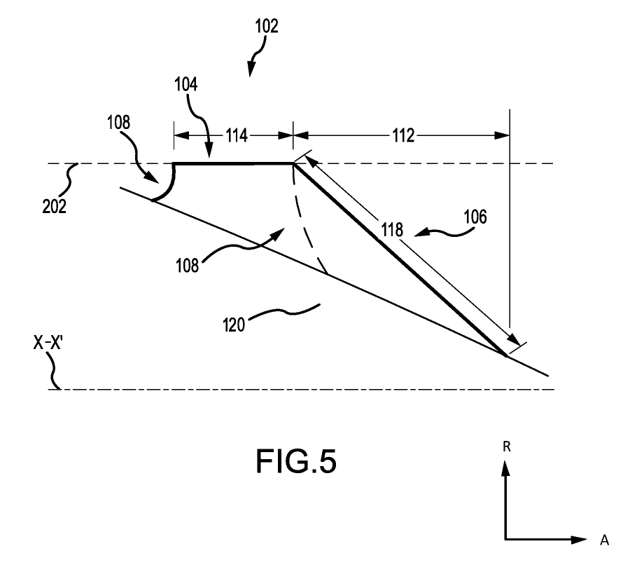

With reference to FIG. 3, a portion of outer case 70 is shown. As described herein, outer case 70 includes support member boss 78, spoke boss 80, gusseted boss 82, and stiffness boss 102. Stiffness boss 102 includes a head portion 104 and a leg portion 106. The head portion 104 is flat and approximately parallel to the engine centerline axis X-X′, as shown in FIGS. 4 and 5. The head portion 104 has a head length 116 and a head width 114. The leg portion 106 is also flat, but sloped downward and radially inward. The leg portion 106 has a leg length 112 and a leg width 110. Head length 116, head width 114, leg length 112, and leg width 110 may be determined such that rigidity provided by the stiffness boss 102 is optimized. Head length 116, head width 114, leg length 112, and leg width 110 may also be determined such that rigidity provided by the stiffness boss 102 is optimized and weight of the stiffness boss 102 is minimized. The dimensions of the head portion 104 and the leg portion 106 may be optimized using virtual modeling of the turbine case, or may be optimized based on fabricating and testing the turbine case with stiffness bosses having various head portion 104 and leg portion 106 dimensions.

The leg portion 106 provides a primary source of rigidity in response to an axial load 302 being applied to the outer case 70 in the positive A direction. When a transverse load 304 is applied to the outer case 70 in the positive C direction, the head portion 104 provides a primary source of rigidity. When a radial load 306 is applied to the outer case 70 in a negative R direction, both the head portion 104 and the leg portion 106 provide rigidity.

The stiffness boss 102 may be made of a metal or metal alloys. In various embodiments, the stiffness boss 102 is made of a nickel superalloy such as an austenitic nickel-chromium-based alloy such as that sold under the trademark Inconel® which is available from Special Metals Corporation of New Hartford, N.Y., USA. The stiffness boss 102 may be made of the same material as the outer case 70, or may be made of a different material from the outer case 70.

The stiffness boss 102 may be welded, brazed, additively manufactured, machined, or cast on to the outer case 70 (and outer case surface 120). Also shown is filleted portion 108, which curves radially inward from the outer case surface 120 to the head portion 104 and to the leg portion 106. The filleted portion 108 may be a result of welding the head portion 104 and the leg portion 106 to the outer case 70 at outer case surface 120. The filleted portion 108 may be part of the design of the stiffness boss 102, which may be cast, additively manufactured, or machined. Filleted portion 108 may provide support for the head portion 104 and the leg portion 106. Filleted portion 108 may also surround the perimeter of the head portion 104 and the leg portion 106.

Stiffness boss 102 provides rigidity for the outer case 70 substantially similar to the rigidity provided by a spoke boss 80 that is not used as an attachment means. As such, stiffness boss 102 may be placed anywhere spoke boss 80 is located. For example, FIG. 2 illustrates alternating between spoke boss 80 and stiffness boss 102 around the circumference of the outer case 70. However, stiffness boss 102 may be located instead of any of the spoke bosses 80, and rigidity of the outer case 70 may be maintained.

While the dimensions of the stiffness boss 102 may contribute to determining the amount of rigidity provided by the stiffness boss 102, the location of the stiffness boss 102 on the outer case 70 may also contribute to the rigidity. Rigidity provided by stiffness boss 102 may vary based on its relative location to spoke boss 80 and support member boss 78.

FIG. 4 illustrates a side view of the stiffness boss 102. As described herein, head portion 104, having head width 114, is approximately parallel to axis X-X′. Shown is head portion surface plane 202 which is approximately parallel to axis X-X′. Also as described herein, outer case surface 120 is sloped radially inward (in the negative R direction and the positive A direction). Leg portion 106 is flat and has a leg length 112 and a leg surface length 118. Filleted portion 108 is also shown, connecting the head portion 104 and the leg portion 106 to the outer case surface 120.

FIG. 5 illustrates a side view of the stiffness boss 102 that is opposite on circumferential axis C of the side view shown in FIG. 4. As described herein, head portion 104, having head width 114, is approximately parallel to axis X-X′. Shown is head portion surface plane 202 which is approximately parallel to axis X-X′. Also as described herein, outer case surface 120 is sloped downward and in the axially forward direction. Leg portion 106 is flat and has a leg length 112 and a leg surface length 118. Filleted portion 108 is also shown, connecting the head portion 104 and the leg portion 106 to the outer case surface 120.

Referring to FIGS. 2 and 3, while stiffness bosses 102 with the head portion 104 being to the left of center of leg portion 106 are shown, the center of head portion 104 may be in a negative C direction of the center of leg portion 106. Further, while stiffness bosses 102 with the head portion 104 being radially outward relative to the leg portion 106 are shown, the head portion 104 may be radially inward relative to the leg portion 106.

While the disclosure is described with reference to exemplary embodiments, it will be understood by those skilled in the art that various changes may be made and equivalents may be substituted without departing from the spirit and scope of the disclosure. In addition, different modifications may be made to adapt the teachings of the disclosure to particular situations or materials, without departing from the essential scope thereof. The disclosure is thus not limited to the particular examples disclosed herein, but includes all embodiments falling within the scope of the appended claims.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A stiffness boss for a turbine case of a gas turbine engine, comprising:
a head portion disposed on an outer case surface of the turbine case, the head portion configured to provide rigidity in response to a transverse load being applied to the turbine case in a transverse direction; and
a leg portion disposed on the outer case surface of the turbine case and connected to the head portion, the leg portion configured to provide rigidity in response to an axial load being applied to the turbine case in an axial direction, such that deformation of the turbine case is resisted.

2. The stiffness boss of claim 1, wherein the head portion and the leg portion provide rigidity in response to a radial load being applied to the turbine case in a radially inward direction.

3. The stiffness boss of claim 1, wherein the head portion has a head length and head width determined to provide optimized rigidity and minimized weight.

4. The stiffness boss of claim 1, wherein the leg portion has a leg length and leg width determined to provide optimized rigidity and minimized weight.

5. The stiffness boss of claim 1, wherein the head portion is flat and is substantially parallel to an axis of the gas turbine engine.

6. The stiffness boss of claim 1, wherein the leg portion is flat and sloped radially inward.

7. The stiffness boss of claim 1, wherein the head portion and the leg portion are connected to the outer case surface by a filleted portion.

8. The stiffness boss of claim 7, wherein the filleted portion is curved radially inward.

9. A turbine case of a gas turbine engine, the turbine case comprising:
an outer case surface;
a support member boss configured to secure support structures of the gas turbine engine;
a stiffness boss disposed on the outer case surface and configured to provide rigidity in response to one or more loads applied to the turbine case, the stiffness boss being different from the support member boss.

10. The turbine case of claim 9, wherein the stiffness boss is a gusseted boss configured to provide rigidity in response to at least one of a transverse load, an axial load, or a radial load applied to the turbine case.

11. The turbine case of claim 9, wherein the stiffness boss comprises:
a head portion configured to provide rigidity in response to a transverse load being applied to the turbine case in a transverse direction, and
a leg portion configured to provide rigidity in response to an axial load being applied to the turbine case in an axial direction, such that deformation of the outer case is resisted.

12. The gas turbine engine of claim 11, wherein the head portion and the leg portion provide rigidity in response to a radial load being applied to the turbine case in a radially inward direction.

13. The gas turbine engine of claim 11, wherein the head portion has a head length and head width determined to provide optimized rigidity and minimized weight.

14. The gas turbine engine of claim 11, wherein the leg portion has a leg length and leg width determined to provide optimized rigidity and minimized weight.

15. The gas turbine engine of claim 11, wherein the head portion is flat and is substantially parallel to an axis of the gas turbine engine.

16. The gas turbine engine of claim 11, wherein the leg portion is flat and sloped radially inward.

17. The gas turbine engine of claim 9, wherein the stiffness boss is at least one of welded, brazed, additively manufactured, machined, or cast on the outer case surface.

18. The gas turbine engine of claim 9, wherein the stiffness boss and the turbine case are made of different materials.

19. A method of fabricating a turbine case, comprising:
disposing a head portion of a stiffness boss on an outer surface of the turbine case, the head portion configured to provide rigidity in response to a transverse load being applied to the turbine case; and
disposing a leg portion of the stiffness boss on the outer surface of the turbine case, the leg portion configured to provide rigidity in response to an axial load being applied to the turbine case.

20. The method of claim 19, further comprising:
determining a head length and a head width of the head portion by optimizing rigidity and minimizing weight; and
determining a leg length and a leg width of the leg portion by optimizing rigidity and minimizing weight.
